(19) United States
(12) Patent Application Publication
(10) Pub. No.: US 2018/0082570 A1
(43) Pub. Date: Mar. 22, 2018

(54) DYNAMIC BATTERY CHARGING THRESHOLD FOR MOBILE DEVICES

(71) Applicant: QUALCOMM Incorporated, San Diego, CA (US)

(72) Inventors: Ankit MAHESHWARI, Hyderabad (IN); Shruti AGRAWAL, Hyderabad (IN); Akash KUMAR, Hyderabad (IN); Atul SONI, Hyderabad (IN)

(21) Appl. No.: 15/270,271

(22) Filed: Sep. 20, 2016

(51) Int. Cl. G08B 21/24; G08B 21/18; G06N 7/00

(52) U.S. Cl. CPC G08B 21/24; H04W 88/02; G06N 7/005; G08B 21/182

(57) ABSTRACT

In one aspect, a method includes maintaining a list of future user events. The list includes a field associated with each of the future user events to indicate whether charging of a mobile device is possible during a respective future user event. The method also includes receiving user input indicating whether charging of the mobile device is possible during at least one of the future user events and updating the field associated with the future user events based on the user input. Also included in the method is setting a battery charging threshold based on one or more of the future user events and based on the fields associated with the future user events. An alert may then be generated prior to a future user event in response to a current battery level of the mobile device being less than the battery charging threshold.

### TECHNICAL FIELD

The various aspects and embodiments described herein generally relate to mobile devices, and more particularly, to setting a battery charging threshold associated with a battery of a mobile device.

### BACKGROUND

Having a sufficiently charged battery in a mobile device, such as a smartphone, is often desirable to a user of the mobile device. Quite often the user ends up in a situation where mobile device's battery is low, but the user is away from their home/workplace and no charging points are available in the vicinity. Current available solutions provide a mechanism to have a fixed battery charging threshold where an alert is generated once the battery charge is below the fixed battery charging threshold. However, a fixed battery charging threshold may not be sufficient where a user's future activities vary. For example, a conventional mobile device may alert a user when the battery of the mobile device drops to below a fixed threshold (e.g., 20 percent). However, the user may have a planned future event (e.g., going to the gym), where a 20 percent remaining battery life is insufficient for the duration of the activity and/or where charging is not possible during the planned future event. Thus, a fixed or static battery charging threshold configuration is not an optimum solution for all scenarios.

### SUMMARY

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein in a simplified form to precede the detailed description presented below.

According to one aspect, a method includes maintaining a list of future user events. The list includes a field associated with each of the future user events to indicate whether charging of a mobile device is possible during a respective future user event. The method also includes receiving user input indicating whether charging of the mobile device is possible during at least one of the future user events and updating the field associated with the future user events based on the user input. Also included in the method is setting a battery charging threshold based on one or more of the future user events and based on the fields associated with the future user events. An alert may then be generated prior to a future user event in response to a current battery level of the mobile device being less than the battery charging threshold.

According to another aspect, a mobile device includes a battery, memory, and a processor coupled to the memory to access and execute instructions included in program code to direct the mobile device to: (i) maintain a list of a plurality of future user events, where the list includes a field associated with each of the plurality of future user events to indicate whether charging of the mobile device is possible during a respective future user event; (ii) receive user input in indicating whether charging of the mobile device is possible during at least one of the plurality of future user events; (iii) update the field associated with the at least one of the plurality of future user events to indicate whether charging of the mobile device is possible during the at least one of the plurality of future user events based on the user input; (iv) set a battery charging threshold associated with the battery of the mobile device based on one or more of the plurality of future user events and based on the field associated with the one or more of the plurality of future user events; and (v) generate an alert prior to the one or more of the plurality of future user events in response to a current battery level of the battery being less than the battery charging threshold.

According to yet another aspect, a non-transitory computer-readable medium includes program code stored thereon for use by a mobile device. The program code includes instructions to direct the mobile device to: (i) maintain a list of a plurality of future user events, where the list includes a field associated with each of the plurality of future user events to indicate whether charging of the mobile device is possible during a respective future user event; (ii) receive user input in indicating whether charging of the mobile device is possible during at least one of the plurality of future user events; (iii) update the field associated with the at least one of the plurality of future user events to indicate whether charging of the mobile device is possible during the at least one of the plurality of future user events based on the user input; (iv) set a battery charging threshold associated with the battery of the mobile device based on one or more of the plurality of future user events and based on the field associated with the one or more of the plurality of future user events; and (v) generate an alert prior to the one or more of the plurality of future user events in response to a current battery level of the battery being less than the battery charging threshold.

According to another aspect, a mobile device includes a battery and a means for maintaining, at the mobile device, a list of a plurality of future user events, where the list includes a field associated with each of the plurality of future user events to indicate whether charging of the mobile device is possible during a respective future user event. The mobile device also includes means for receiving, at the mobile device, user input in indicating whether charging of the mobile device is possible during at least one of the plurality of future user events, as well as means for updating the field associated with the at least one of the plurality of future user events to indicate whether charging of the mobile device is possible during the at least one of the plurality of future user events based on the user input. Further included in the mobile device are means for setting a battery charging threshold associated with the battery of the mobile device based on one or more of the plurality of future user events and based on the field associated with the one or more of the plurality of future user events, and means for generating an alert prior to the one or more of the plurality of future user events in response to a current battery level of the battery being less than the battery charging threshold.

Other objects and advantages associated with the aspects and embodiments disclosed herein will be apparent to those skilled in the art based on the accompanying drawings and detailed description.

### BRIEF DESCRIPTION OF THE DRAWINGS

A more complete appreciation of the various aspects and embodiments described herein and many attendant advantages thereof will be readily obtained as the same becomes better understood by reference to the following detailed description when considered in connection with the accompanying drawings which are presented solely for illustration and not limitation, and in which:

FIG. 1 illustrates an example process of dynamically setting a battery charging threshold, according to various aspects.

FIG. 2 illustrates an example list of future user events, according to various aspects.

FIG. 3A illustrates an example calendar including a plurality of calendar events, according to various aspects.

FIG. 3B illustrates an example alert generated in response to a current battery level of a mobile device being less than the battery charging threshold, according to various aspects.

FIG. 4 illustrates an example process of setting a battery charging threshold, according to various aspects.

FIG. 5 illustrates an example high-level system architecture of a wireless communication system that may include various Internet of Things (IoT) devices, according to various aspects.

FIG. 6 illustrates a mobile device, according to various aspects.

FIG. 7 illustrates a mobile device that includes various structural components configured to perform functionality, according to various aspects.

FIG. 8 is a simplified block diagram of several sample aspects of a mobile device configured to support the dynamic setting of a battery charging threshold, according to various aspects.

### DETAILED DESCRIPTION

Various aspects and embodiments are disclosed in the following description and related drawings to show specific examples relating to exemplary aspects and embodiments. Alternate aspects and embodiments will be apparent to those skilled in the pertinent art upon reading this disclosure, and may be constructed and practiced without departing from the scope or spirit of the disclosure. Additionally, well-known elements will not be described in detail or may be omitted so as to not obscure the relevant details of the aspects and embodiments disclosed herein.

The word “exemplary” is used herein to mean “serving as an example, instance, or illustration.” Any embodiment described herein as “exemplary” is not necessarily to be construed as preferred or advantageous over other embodiments. Likewise, the term “embodiments” does not require that all embodiments include the discussed feature, advantage or mode of operation.

The terminology used herein describes particular embodiments only and should not be construed to limit any embodiments disclosed herein. As used herein, the singular forms “a,” “an,” and “the” are intended to include the plural forms as well, unless the context clearly indicates otherwise. Those skilled in the art will further understand that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Further, many aspects are described in terms of sequences of actions to be performed by, for example, elements of a computing device. Those skilled in the art will recognize that various actions described herein can be performed by specific circuits (e.g., an application specific integrated circuit (ASIC)), by program instructions being executed by one or more processors, or by a combination of both. Additionally, the sequence of actions described herein can be considered to be embodied entirely within any form of non-transitory computer readable storage medium having stored therein a corresponding set of computer instructions that upon execution would cause an associated processor to perform the functionality described herein. Thus, the various aspects described herein may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As mentioned above, conventional devices that utilize a fixed or static battery charging threshold configuration may not provide sufficient notification to the user to charge the battery for all scenarios, especially when a user's future activities vary. For example, a static battery charging threshold may not provide enough charge of the battery if the user has a day outing planned where no charging is possible during the outing. Furthermore, a fixed battery charging threshold may be too high for scenarios where charging is available during a planned event. Even still, a fixed battery charging threshold may be too high for scenarios where the mobile device will simply be in an idle state consuming little power. Accordingly, aspects of the present disclosure address the above-mentioned problem by dynamically setting a battery charging threshold. In one example, future user events are accounted for in dynamically setting the battery charging threshold. In another example, past user events and/or prior history of battery usage may be taken into account when setting the battery charging threshold. In some examples, the battery charging threshold can be varied depending on a duration of the future user event and/or based on a prior history of battery usage for a matching past user event. Even still, in some examples the time before which the user needs to be alerted can vary depending upon a time the mobile device takes to charge the battery to at least the battery charging threshold and/or to charge the battery completely.

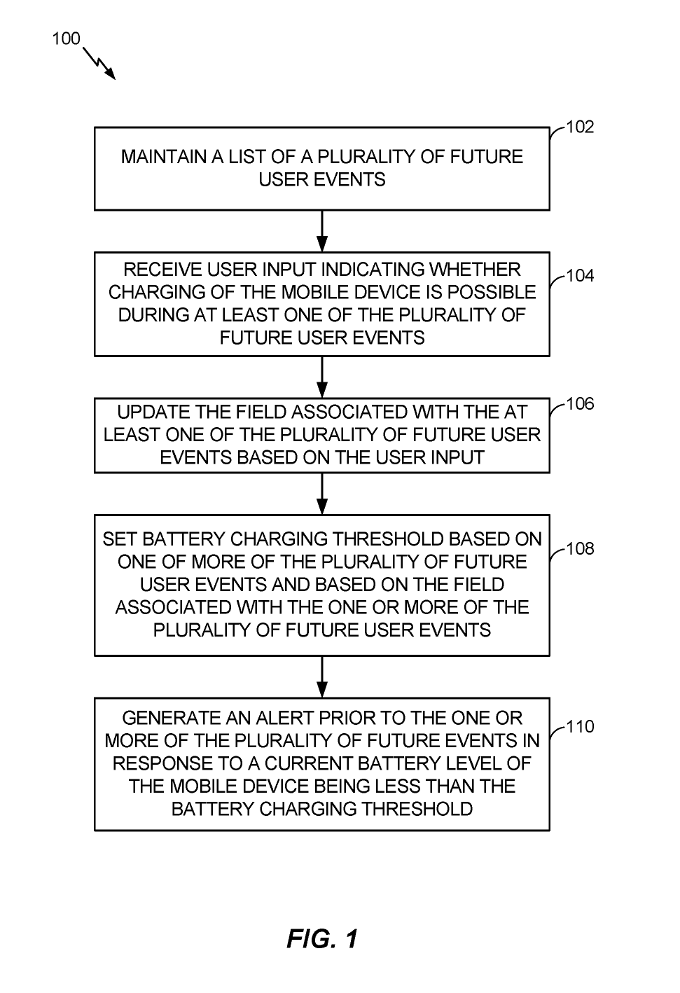

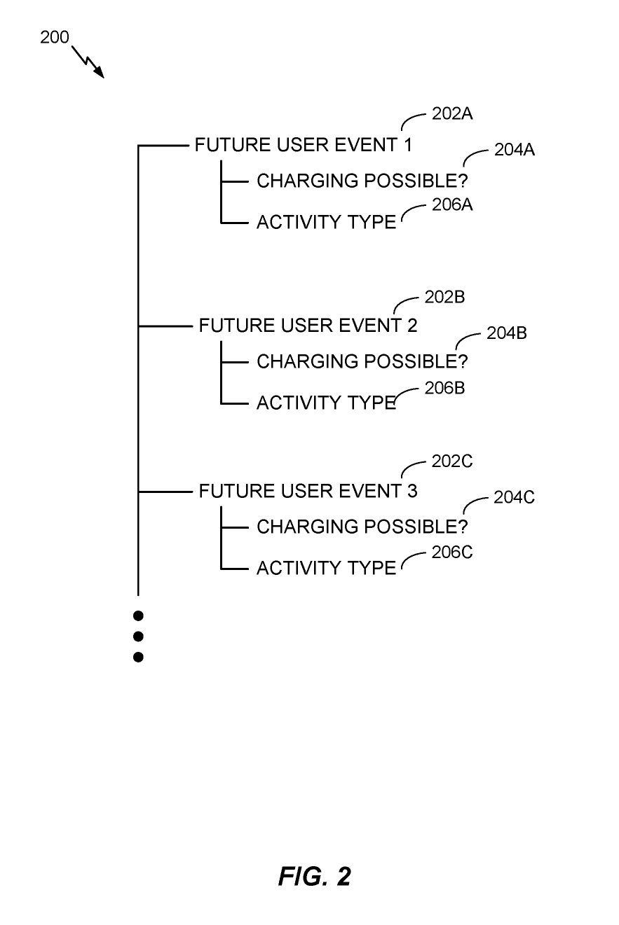

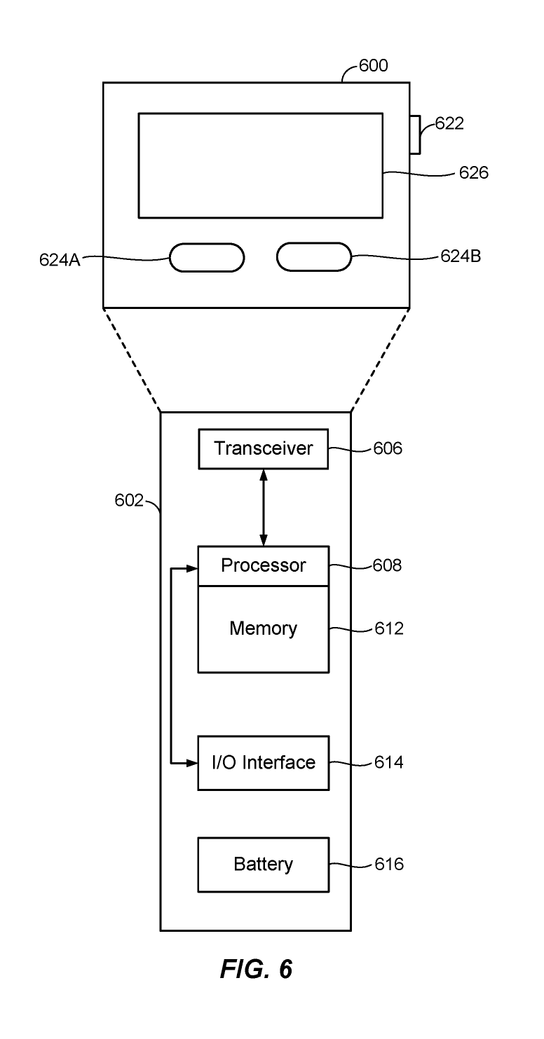

FIG. 1 illustrates an example process 100 of dynamically setting a battery charging threshold, according to various aspects. Process 100 is one possible process performed by a mobile device, such as mobile device 600, described in further detail below with reference to FIG. 6. In a process block 102, a mobile device maintains a list of a plurality of future user events. In one aspect, the future user events correspond to events planned by a user of the mobile device. That is, the future user events to be performed by the user while in possession of the mobile device such as, traveling, participating in a meeting, a function, exercising at a gym, going for a walk, etc. FIG. 2 illustrates an example list 200 of future user events, according to various aspects. As shown in FIG. 2, list 200 includes several future user events 202A-202C. Each of the future user events 202A-202C may correspond to an event that a user of the mobile device plans to participate in. Each of the future user events 202A-202C also includes a first field 204A-204C, respectively. The first fields 204A-204C indicate whether charging of the mobile device is possible during a respective future user event. That is, first field 204A indicates whether charging of the mobile device will be possible during the future user event 202A, while first field 204B indicates whether charging of the mobile device will be possible during the future user event 202B. In one aspect, charging of a mobile device is possible if there will be charging points (e.g., accessible power outlets) at a location associated with the future user event. In other examples, charging of the mobile device is possible if there will be wireless charging available at the location associated with the future user event.

As further shown in FIG. 2, each of the future user events 202A-202C may optionally include a second field 206A-206C, respectively. The second fields 206A-206C indicate an activity type of a respective future user event 202A-202C. That is, second field 206A indicates an activity type of the future user event 202A, while second field 206B indicates an activity type of the future user event 202B. In some aspects, the activity type of the second field corresponds to a category assigned to the future user event. For example, a future user event of “trip to San Diego” may include a second field corresponding to an activity type of “travel”, or a future user event of “go for a jog” may include a second field corresponding to an activity type of “outdoors”. As will be described in further detail below, the mobile device may be configured to determine whether charging of the mobile device is possible based, in part, on the activity type indicated in the second fields 206A-206C (e.g., no charging may be possible when the activity type is “outdoors”). In other examples, the mobile device may be configured to associate at least some of the activity types with a higher expected battery usage than other activity types. For example, an activity type of “video teleconference via mobile device” may be associated with a higher expected battery usage than an activity type of “in-person meeting”.

Although FIG. 2 illustrates each future user event 202A-202C as including only a first field 204A-204C and a second field 206A-206C, each future user event 202A-202C may include further fields not illustrated in FIG. 2. For example, each future user event 202A-202C may include an optional field corresponding to a start time and/or date that the future user event is to commence, as well as an optional field corresponding to a duration of the future user event.

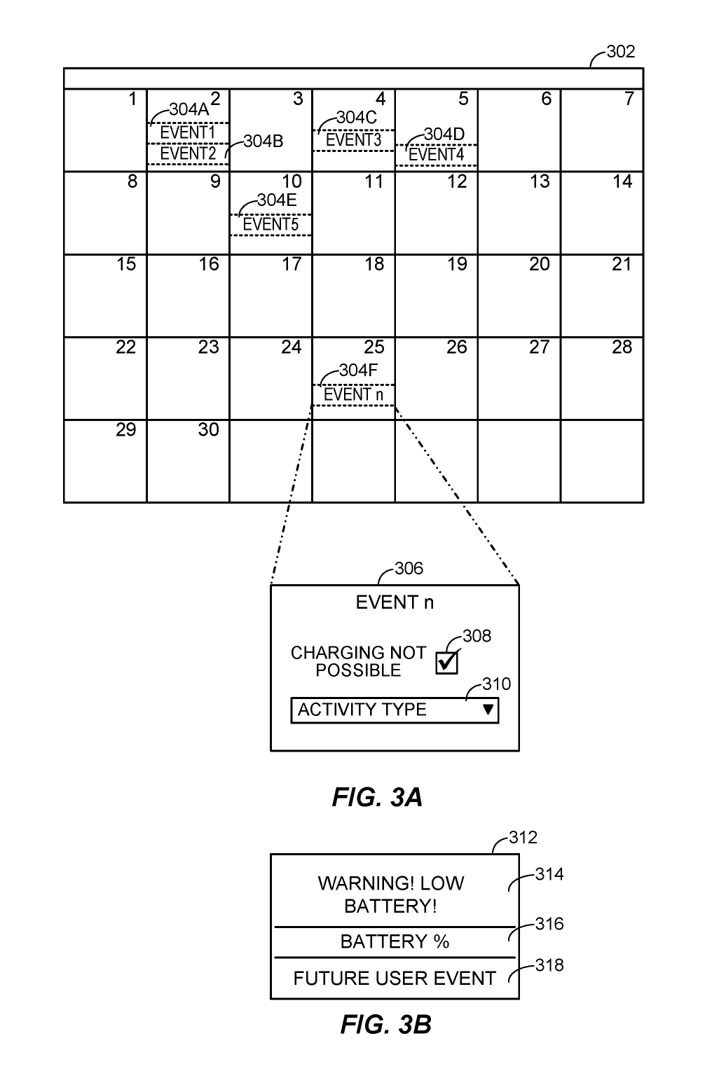

In some examples, maintaining the list of the future user events may include maintaining a calendar of the future user events, where each of the future user events is a calendar entry in the calendar. For example, FIG. 3A illustrates a possible implementation of a calendar 302 including a plurality of calendar events 304A-304F, according to various aspects. As used herein, calendar 302 may be a system of organizing days for future user events, such as for social, religious, commercial or administrative purposes. Calendar 302 may provide such organization by giving names to periods of time, typically days, weeks, months, and/or years. The view of calendar 302 is illustrated in FIG. 3A as a full month view, but in other examples, calendar 302 can be presented as a single day, a week (e.g., Sunday through Saturday), or even just a work week (e.g., Monday through Friday). Even still, calendar 302 may be viewed simply as a list of future user events.

Each of the calendar events 304A-304F may correspond to a future user event and may include the associated fields (e.g., first and second fields, 204A-204C and 206A-206C shown in FIG. 2). In one aspect, the calendar 302 is presented to the user of the mobile device as a user interface that allows the user to enter, edit, and/or delete calendar events into the calendar 302.

Returning now to FIG. 1, process block 104 includes receiving user input indicating whether charging of the mobile device is possible during at least one of the future user events included in the list of future user events. In one aspect, receiving the user input may include generating a user interface that allows the user of the mobile device to indicate whether charging of the mobile device is indeed possible during a future user event. By way of example, FIG. 3A illustrates a user interface 306 presented to the user of the mobile device. User interface 306 corresponds to the calendar event 304F of calendar 302. In one aspect, user interface 306 may be initiated by the user generating, selecting, or otherwise interacting with the calendar event 304F. As shown, in FIG. 3A, user interface 306 provides the user an option to classify the calendar entry 304F as a future user event where charging of the mobile device is not possible. While user interface 306 illustrates user interface 306 as including checkbox 308 to allow the user to indicate that charging of the mobile device is not possible during the calendar entry 304F, other user interface mechanisms may be implemented, such as a button, slide bar, text input, gesture recognition, etc.

Optionally included in user interface 306 is an option for the user to assign an activity type of the calendar entry 304F. While user interface 306 illustrates user interface 306 as including a pull-down menu 310 to allow the user to select the activity type of the calendar entry 304F, other user interface mechanisms may be implemented, such as a selectable list, buttons, slide bars, text input, gesture recognition, etc. In one aspect, the pull-down menu 310 provides the user with a number of activity types to choose from. The activity types may be predetermined and/or may be user definable.

Returning again to FIG. 1, in process block 106, the field (e.g., first field 204A) associated with the future user event is updated based on the user input. That is, the user may provide user input by way of user interface 306 to indicate that charging of the mobile device is possible, where process block 106 then includes updating the first field associated with a respective future user event to indicate whether charging is indeed possible. Next, in process block 108, the battery charging threshold is set based on one or more of the future events included in the list of future events and also based on the field (e.g., first fields 204A-204C) associated with the one or more future events. As will be described in more detail below, the setting of the battery charging threshold may include setting the battery charging threshold to a value based on whether charging is available or not available during an upcoming future user event. In other examples, setting the battery charging threshold may include setting the battery charging threshold based on one or more past user events and/or based on prior history of battery usage. These examples, as well as others, of dynamically setting the battery charging threshold will be described in further detail below.

Next, in process block 110, an alert is generated prior to one or more of the future events in response to a current battery level of the mobile device being less than the battery charging threshold. In one aspect, generating the alert may include generating a pop-up window to present to a user of the mobile device that charging of the mobile device is needed. By way of example, FIG. 3B illustrates one possible implementation of an alert 312 generated in response to a current battery level of a mobile device being less than the battery charging threshold. As mentioned above, alert 312 may be presented to the user of the mobile device as a pop-up window. However, in other examples, alert 312 may be presented to the user by way of an audio alert, a haptic feedback (e.g., vibration), or any other notification to the user of the mobile device.

As shown in FIG. 3B, alert 312 may include a notification 314 warning the user that the battery is low and that charging of the mobile device is needed. Optionally included in alert 312 is a notification 316 of the remaining battery life of the mobile device. In one aspect, notification 316 is presented as a numerical percentage of the remaining battery life. However, other examples of notification 316 may include the battery life being represented graphically as a shaded bar illustrating the relative battery life remaining. Also, optionally included in alert 312 is an indication of a future user event 318. In one aspect, the future user event 318 may be included in the alert 312 to notify the user of why charging of the mobile device is necessary and/or which future user event prompted the alert 312. In one example, the alert 312 may be presented to the user once. In other examples, the alert 312 may be presented to the user periodically until the mobile device detects that the user has initiated charging of the mobile device (e.g., by connecting mobile device to a power supply).

In one example, process block 110 may optionally include determining whether wireless charging is currently available for the mobile device, and then automatically initiating wireless charging in response to the current battery level of the mobile device being less than the battery charging threshold. The automatic initialization of wireless charging may be in lieu of, or in addition to generating alert 312.

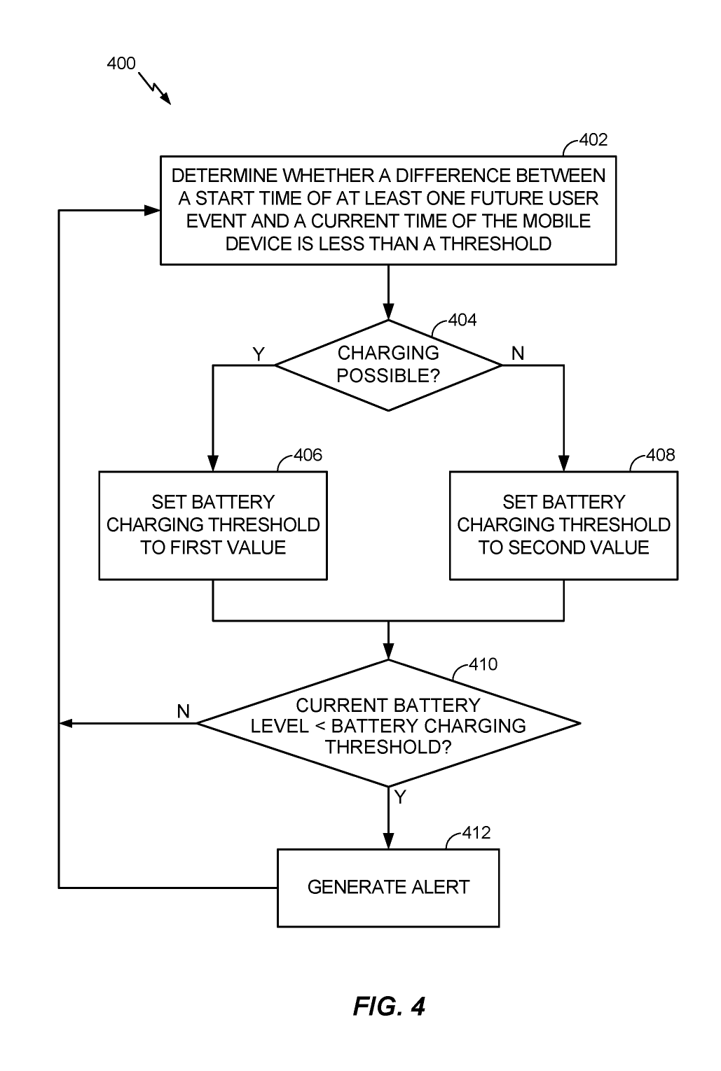

FIG. 4 illustrates an example process 400 of setting a battery charging threshold, according to various aspects. Process 400 is one possible implementation of process block 108 and 110 of FIG. 1. As mentioned above, each future user event of the list of future events (e.g., future user events 202A-202C of list 200) may include an optional field corresponding to a start time and/or date that the future user event is to commence. Thus, in a process block 402, the mobile device determines whether a difference between a start time of at least one of the future user event and a current time of the mobile device (e.g., obtained from a system clock of the mobile device) is less than a threshold. In one example, this determination may be made by the mobile device traversing the list of future user events, such as calendar 302 of FIG. 3, to determine which, if any, of the future user events will commence within a threshold amount of time. In some aspects, the threshold relates to an amount of time that is needed before the future user event to charge the battery of the mobile device to at least the battery charging threshold or, alternatively to fully charge the battery. The threshold amount of time may be predetermined or may be user definable. In one example, the threshold amount of time may be based on a prior charging history of the mobile device. For example, the mobile device may be configured to maintain a prior charging history that indicates the rate and/or total time needed to charge the battery of the mobile device. Thus, the threshold utilized in process block 402 may be, at least, the minimum time needed, based on the prior charging history, needed to charge the battery.

Once it is determined that a future user event will indeed commence within the threshold amount of time, decision block 404 determines whether a field (e.g., first fields 204A-204C) associated with the future user event indicates that charging of the mobile device will be possible during the future user event. If so, process block 406 includes setting the battery charging threshold to a first value. If not, process block 408 includes setting the battery charging threshold to a second value. In one example, the second value is greater than the first value. That is, if no charging is possible during the future user event, then the battery charging threshold is set to a higher second value to ensure a sufficient charge is present on the mobile device since no charging will be possible. Similarly, if charging is possible during the future user event, the battery charging threshold is set to the lower first value to prevent unnecessary charging at this time since charging will be possible during the future user event.

Next, in decision block 410, the mobile device determines whether the current battery level of the mobile device is less than the battery charging threshold. If so, process block 412 includes generating an alert (e.g., alert 312). If not, process 400 may return to process block 402 to continue monitoring for upcoming future user events.

In some examples, the mobile device may be configured to maintain a charging history associated with at least one past user event. Maintaining the charging history may include recording whether charging of the mobile device was performed during the past user event. For example, referring to calendar 302 of FIG. 3A, assuming the current date corresponds to the 25^{th}, as shown, the mobile device may maintain a charging history related to past user events (e.g., calendar events 304A-304F), indicating whether charging was performed during these past user events. In setting the battery charging threshold in response to a future user event (e.g., calendar event 304F), the mobile device may then determine whether the future user event 304F matches any of the past user events 304A-304E. A future user event 304F may match a past user event 304A-304E if they have the same or similar description, as entered by the user, and/or the same activity type as indicated in the second fields 206A-206C. In some aspects, the charging history of matching past user events may override the user input indicating whether charging will be available during the future user event. For example, assume that the first field associated with the future user event 304F indicates that charging will not be possible during the future user event 304F. However, future user event 304F matches a past user event 304A, where the prior charging history indicates that charging did indeed occur during the past user event 304A. Thus, in this example, the mobile device may be configured to set the battery charging threshold to the lower first value (e.g., process block 406) regardless of whether the user input indicated that charging will not be possible.

By way of another example, assume that the first field associated with the future user event 304F indicates that charging will be possible during the future user event 304F. However, the prior charging history indicates that charging is not possible during the past user event 304A. Thus, in this example, the mobile device may be configured to set the battery charging threshold to the higher second value (e.g., process block 408) regardless of whether the user input indicated that charging will be possible.

In some examples, the first and second values for the battery charging threshold are predetermined. However, in other examples, the first and second values for the battery charging threshold may be dynamically determined by the mobile device. For example, in some aspects, the mobile device may be configured to determine an expected battery usage during a future user event, where setting the battery charging threshold is based, in part, on the expected battery usage. In one aspect, determining the expected battery usage may be based on the activity type and/or duration of the associated future user event. That is, when determining the expected battery usage, the mobile device may set the value of the battery charging threshold based on the activity type indicated in the second fields 206A-206C. For example, the mobile device may include a list of known battery usages for the mobile device related to various activity types. Thus, the list of known battery usages may include a known battery usage for an activity type of “video teleconference via mobile device” and a known battery usage of an activity type of “idle mode”. The list of know battery usages may be predetermined and fixed and/or may include battery usages based on a prior history of battery usage during one or more past user events.

Aspects of the present disclosure may also be applicable to a wireless communication system that includes one or more Internet of Things (IoT) devices, such as may be deployed in a smart home scenario. In one example, the mobile device may be configured to receive from another device, an indication of a planned power outage at a location, associate the location with one or more future user events, and set the battery charging threshold based on the indication of the planned power outage. For example, a power meter IoT device may be configured to inform a mobile device of a planned power outage in an area where no power backup will be available. In this case, the mobile device may further adjust/set the battery charging threshold based on this indication from the power meter IoT device of the planned power outage. That is, the battery charging threshold may be increased to ensure continued operation of the mobile device throughout the future user event that overlaps with the planned power outage.

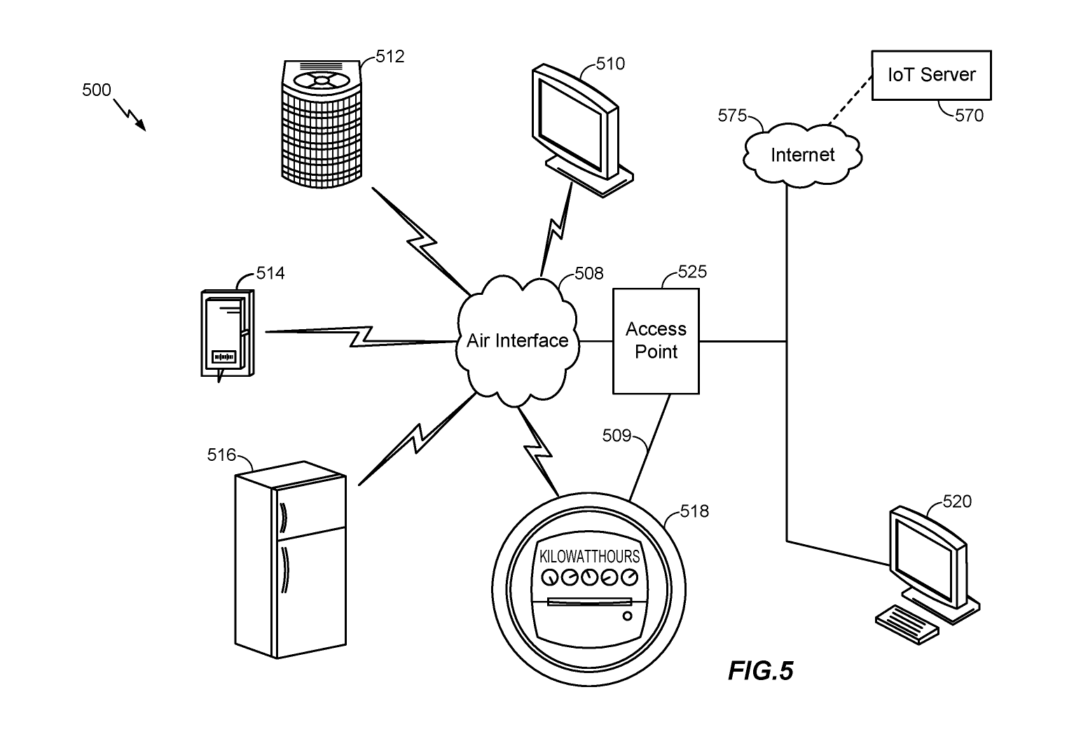

FIG. 5 illustrates an example high-level system architecture of a wireless communication system that may include various Internet of Things (IoT) devices, according to various aspects. As used herein, the term “Internet of Things device” (or “IoT device”) may refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

The wireless communications system 500 contains a plurality of IoT devices, which include a television 510, an outdoor air conditioning unit 512, a thermostat 514, a refrigerator 516, and a power meter 518.

IoT devices 510-518 are configured to communicate with an access network (e.g., an access point 525) over a physical communications interface or layer, shown in FIG. 5 as air interface 508 and a direct wired connection 509. The air interface 508 can comply with a wireless Internet protocol (IP), such as IEEE 802.11. Although FIG. 5 illustrates IoT devices 510-518 communicating over the air interface 508 and IoT device 518 communicating over the direct wired connection 509, each IoT device may communicate over a wired or wireless connection, or both.

The Internet 575 includes a number of routing agents and processing agents (not shown in FIG. 5 for the sake of convenience). The Internet 575 is a global system of interconnected computers and computer networks that uses a standard Internet protocol suite (e.g., the Transmission Control Protocol (TCP) and IP) to communicate among disparate devices/networks. TCP/IP provides end-to-end connectivity specifying how data should be formatted, addressed, transmitted, routed and received at the destination.

In FIG. 5, a computer 520, such as a desktop or personal computer (PC), is shown as connecting to the Internet 575 directly (e.g., over an Ethernet connection or Wi-Fi or 802.11-based network). The computer 520 may have a wired connection to the Internet 575, such as a direct connection to a modem or router, which, in an example, can correspond to the access point 525 (e.g., for a Wi-Fi router with both wired and wireless connectivity). Alternatively, rather than being connected to the access point 525 and the Internet 575 over a wired connection, the computer 520 may be connected to the access point 525 over air interface 508 or another wireless interface, and access the Internet 575 over the air interface 508. Although illustrated as a desktop computer, computer 520 may be a laptop computer, a tablet computer, a PDA, a smart phone, or the like. The computer 520 may be an IoT device and/or contain functionality to manage an IoT network/group, such as the network/group of IoT devices 510-518.

The access point 525 may be connected to the Internet 575 via, for example, an optical communication system, such as FiOS, a cable modem, a digital subscriber line (DSL) modem, or the like. The access point 525 may communicate with IoT devices 510-1520 and the Internet 575 using the standard Internet protocols (e.g., TCP/IP).

Referring to FIG. 5, an IoT server 570 is shown as connected to the Internet 575. The IoT server 570 can be implemented as a plurality of structurally separate servers, or alternately may correspond to a single server. In various embodiments, the IoT server 570 may be optional (as indicated by the dotted line), and the group of IoT devices 510-520 may be a peer-to-peer (P2P) network. In such a case, the IoT devices 510-520 can communicate with each other directly over the air interface 508 and/or the direct wired connection 509 using appropriate device-to-device (D2D) communication technology. Alternatively, or additionally, some or all of the IoT devices 510-520 may be configured with a communication interface independent of the air interface 508 and the direct wired connection 509. For example, if the air interface 508 corresponds to a Wi-Fi interface, one or more of the IoT devices 510-520 may have Bluetooth or NFC interfaces for communicating directly with each other or other Bluetooth or NFC-enabled devices.

In a peer-to-peer network, service discovery schemes can multicast the presence of nodes, their capabilities, and group membership. The peer-to-peer devices can establish associations and subsequent interactions based on this information.

The Internet 575 is a “resource” that can be regulated using the concept of the IoT. However, the Internet 575 is just one example of a resource that is regulated, and any resource could be regulated using the concept of the IoT. Other resources that can be regulated include, but are not limited to, electricity (e.g., by way of power meter IoT device 518), gas, storage, security, and the like. An IoT device may be connected to the resource and thereby regulate the resource, or the resource could be regulated over the Internet 575.

IoT devices can communicate with each other to regulate their use of a resource. For example, IoT devices such as a toaster, a computer, and a hairdryer may communicate with each other over a Bluetooth communication interface to regulate their use of electricity. As another example, IoT devices such as a desktop computer, a telephone, and a tablet computer may communicate over a Wi-Fi communication interface to regulate their access to the Internet 575. As yet another example, IoT devices such as a stove, a clothes dryer, and a water heater may communicate over a Wi-Fi communication interface to regulate their use of gas. In yet another example, power meter IoT device 518 may be configured to inform a mobile device via air interface 508 of a planned power outage. In this case, the mobile device may further adjust/set the battery charging threshold based on this indication from the power meter IoT device 518 of the planned power outage. For example, the battery charging threshold may be increased or set to a higher value to ensure continued operation of the mobile device throughout a future user event that overlaps with the planned power outage.

FIG. 6 illustrates a mobile device 600, according to various aspects. As shown in FIG. 6, in an example configuration for the mobile device 600, an external casing of mobile device 600 may be configured with a display 626, a power button 622, and two control buttons 624A and 624B, among other components, as is known in the art. The display 626 may be a touchscreen display, in which case the control buttons 624A and 624B may not be necessary. While not shown explicitly as part of mobile device 600, the mobile device 600 may include one or more external antennas and/or one or more integrated antennas that are built into the external casing, including but not limited to Wi-Fi antennas, cellular antennas, satellite position system (SPS) antennas (e.g., global positioning system (GPS) antennas), and so on.

While internal components of mobile device 600 can be embodied with different hardware configurations, a basic high-level configuration for internal hardware components is shown as platform 602 in FIG. 6. The platform 602 can receive and execute software applications, data and/or commands transmitted over a network interface, such as air interface 508 in FIG. 5 and/or a wired interface. The platform 602 can also independently execute locally stored applications. The platform 602 can include one or more transceivers 606 configured for wired and/or wireless communication (e.g., a Wi-Fi transceiver, a Bluetooth transceiver, a cellular transceiver, a satellite transceiver, a GPS or SPS receiver, etc.) operably coupled to one or more processors 608, such as a microcontroller, microprocessor, application specific integrated circuit, digital signal processor (DSP), programmable logic circuit, or other data processing device, which will be generally referred to as processor 608. The processor 608 can execute application programming code including instructions within a memory 612 of the mobile device 600. The memory 612 can include one or more of read-only memory (ROM), random-access memory (RAM), electrically erasable programmable ROM (EEPROM), flash cards, or any memory common to computer platforms. One or more input/output (I/O) interfaces 614 can be configured to allow the processor 608 to communicate with and control from various I/O devices such as the display 626, power button 622, control buttons 624A and 624B as illustrated, and any other devices, such as sensors, actuators, relays, valves, switches, and the like associated with the mobile device 600. Further included in mobile device 600 is a battery 616 which is configured to provide power to operate the various components of platform 602.

Accordingly, various aspects can include a mobile device (e.g., mobile device 600) including the ability to perform the functions described herein. As will be appreciated by those skilled in the art, the various logic elements can be embodied in discrete elements, software modules executed on a processor (e.g., processor 608) or any combination of software and hardware to achieve the functionality disclosed herein. For example, transceiver 606, processor 608, memory 612, and I/O interface 614 may all be used cooperatively to load, store and execute the various functions disclosed herein and thus the logic to perform these functions may be distributed over various elements. Alternatively, the functionality could be incorporated into one discrete component. For example, memory 612 may be configured to store program code, where processor 608 is coupled to the memory 612 to access and execute instructions included in the program code. The instructions included in the program code may direct the mobile device 600 to perform one or more of the process blocks 102-110 of process 100 of FIG. 1 and/or one or more of the process blocks 402-412 of process 400 of FIG. 4. Therefore, the features of the mobile device 600 in FIG. 6 are to be considered merely illustrative and the mobile device 600 is not limited to the illustrated features or arrangement shown in FIG. 6.

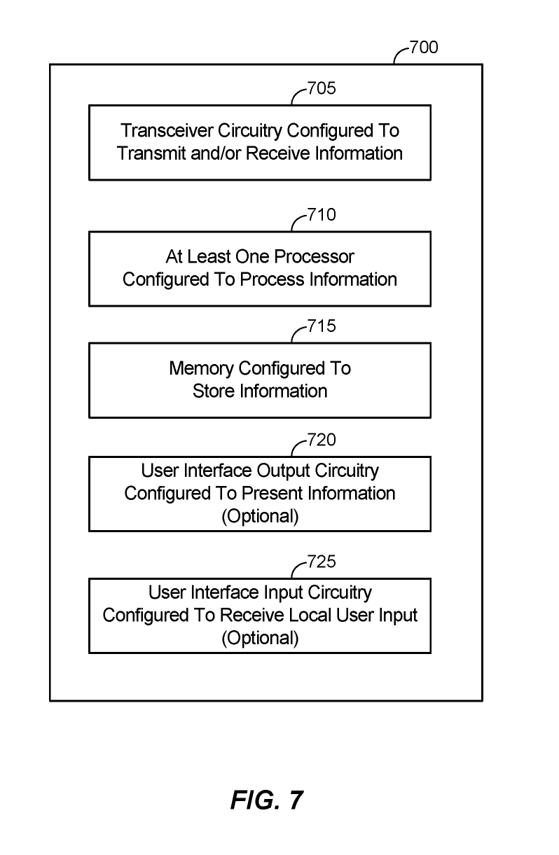

FIG. 7 illustrates a mobile device 700 that includes various structural components configured to perform functionality, according to various aspects. The mobile device 700 can correspond to any of the mobile devices described in further detail above. Accordingly, those skilled in the art will appreciate that the mobile device 700 shown in FIG. 7 can correspond to any electronic device configured to communicate with and/or facilitate communication with one or more other entities, such as in the wireless communications system 500 as shown in FIG. 5.

Referring to FIG. 7, the mobile device 700 includes transceiver circuitry configured to transmit and/or receive information 705. In an example, the transceiver circuitry configured to transmit and/or receive information 705 can include a wireless communications interface (e.g., Bluetooth, Wi-Fi, Wi-Fi Direct, Long-Term Evolution (LTE) Direct, etc.) such as a wireless transceiver and associated hardware (e.g., an RF antenna, a MODEM, a modulator and/or demodulator, etc.). In another example, the transceiver circuitry configured to transmit and/or receive information 705 can correspond to a wired communications interface (e.g., a serial connection, a USB or Firewire connection, an Ethernet connection through which the Internet 575 can be accessed, etc.). In a further example, the transceiver circuitry configured to transmit and/or receive information 705 can include sensory or measurement hardware by which the mobile device 700 can monitor a local environment associated therewith (e.g., an accelerometer, a temperature sensor, a light sensor, an antenna for monitoring local RF signals, etc.). The transceiver circuitry configured to transmit and/or receive information 705 can also include software that, when executed, permits the associated hardware of the transceiver circuitry configured to transmit and/or receive information 705 to perform the reception and/or transmission function(s) associated therewith. However, the transceiver circuitry configured to transmit and/or receive information 705 does not correspond to software alone, and the transceiver circuitry configured to transmit and/or receive information 705 relies at least in part upon structural hardware to achieve the functionality associated therewith.

Referring to FIG. 7, the mobile device 700 further includes at least one processor configured to process information 710. Example implementations of the type of processing that can be performed by the at least one processor configured to process information 710 includes but is not limited to performing determinations, establishing connections, making selections between different information options, performing evaluations related to data, interacting with sensors coupled to the mobile device 700 to perform measurement operations, converting information from one format to another (e.g., between different protocols such as .wmv to .avi, etc.), and so on. For example, the at least one processor configured to process information 710 can include a general purpose processor, a DSP, an ASIC, a field programmable gate array (FPGA) or other programmable logic device, discrete gate or transistor logic, discrete hardware components, or any combination thereof designed to perform the functions described herein. A general purpose processor may be a microprocessor, but in the alternative, the at least one processor configured to process information 710 may be any conventional processor, controller, microcontroller, or state machine. The at least one processor configured to process information 710 may also be implemented as a combination of computing devices (e.g., a combination of a DSP and a microprocessor, a plurality of microprocessors, one or more microprocessors in conjunction with a DSP core, or any other such configuration). The at least one processor configured to process information 710 can also include software that, when executed, permits the associated hardware of the at least one processor configured to process information 710 to perform the processing function(s) associated therewith. However, the at least one processor configured to process information 710 does not correspond to software alone, and the at least one processor configured to process information 710 relies at least in part upon structural hardware to achieve the functionality associated therewith.

Referring to FIG. 7, the mobile device 700 further includes memory configured to store information 715. In an example, the memory configured to store information 715 can include at least a non-transitory memory and associated hardware (e.g., a memory controller, etc.). For example, the non-transitory memory included in the memory configured to store information 715 can correspond to RAM, flash memory, ROM, erasable programmable ROM (EPROM), EEPROM, registers, hard disk, a removable disk, a CD-ROM, or any other form of storage medium known in the art. The memory configured to store information 715 can also include software that, when executed, permits the associated hardware of the memory configured to store information 715 to perform the storage function(s) associated therewith. However, the memory configured to store information 715 does not correspond to software alone, and the memory configured to store information 715 relies at least in part upon structural hardware to achieve the functionality associated therewith. For example, the memory configured to store information 715 may be a non-transitory computer-readable medium that includes program code stored thereon for use by the mobile device 700. The program code may include instructions to direct the mobile device 700 to perform one or more of the process blocks 102-110 of process 100 of FIG. 1 and/or one or more of the process blocks 402-412 of process 400 of FIG. 4.

Referring to FIG. 7, the mobile device 700 further optionally includes user interface output circuitry configured to present information 720. In an example, the user interface output circuitry configured to present information 720 can include at least an output device and associated hardware. For example, the output device can include a video output device (e.g., a display screen, a port that can carry video information such as USB, HDMI, etc.), an audio output device (e.g., speakers, a port that can carry audio information such as a microphone jack, USB, HDMI, etc.), a vibration device and/or any other device by which information can be formatted for output or actually outputted by a user or operator of the mobile device 700. For example, the user interface output circuitry configured to present information 720 can include the display 626. Thus, in some aspects, the user interface output circuitry configured to present information 720 may be configured to present a user interface that includes calendar 302 of FIG. 3A, as well as user interface 306, and/or alert 312. In a further example, the user interface output circuitry configured to present information 720 can be omitted for certain mobile devices, such as network devices that do not have a local user (e.g., network switches or routers, remote servers, etc.). The user interface output circuitry configured to present information 720 can also include software that, when executed, permits the associated hardware of the user interface output circuitry configured to present information 720 to perform the presentation function(s) associated therewith. However, the user interface output circuitry configured to present information 720 does not correspond to software alone, and the user interface output circuitry configured to present information 720 relies at least in part upon structural hardware to achieve the functionality associated therewith.

Referring to FIG. 7, the mobile device 700 further optionally includes user interface input circuitry configured to receive local user input 725. In an example, the user interface input circuitry configured to receive local user input 725 can include at least a user input device and associated hardware. For example, the user input device can include buttons, a touchscreen display, a keyboard, a camera, an audio input device (e.g., a microphone or a port that can carry audio information such as a microphone jack, etc.), and/or any other device by which information can be received from a user or operator of the mobile device 700. For example, the user interface input circuitry configured to receive local user input 725 can include the buttons 622, 624A, and 624B, the display 626 (if a touchscreen), etc. Thus, in some aspects, the user interface input circuitry configured to receive local user input 725 may be configured to receive user input indicating whether charging of the mobile device 700 is possible (e.g., process block 104 of FIG. 1) via user interface 306 of FIG. 3A. In a further example, the user interface input circuitry configured to receive local user input 725 can be omitted for certain devices, such as network devices that do not have a local user (e.g., network switches or routers, remote servers, etc.). The user interface input circuitry configured to receive local user input 725 can also include software that, when executed, permits the associated hardware of the user interface input circuitry configured to receive local user input 725 to perform the input reception function(s) associated therewith. However, the user interface input circuitry configured to receive local user input 725 does not correspond to software alone, and the user interface input circuitry configured to receive local user input 725 relies at least in part upon structural hardware to achieve the functionality associated therewith.

Referring to FIG. 7, while the structural components 705 through 725 are shown as separate or distinct blocks in FIG. 7, those skilled in the will appreciate that the various structural components 705 through 725 may be coupled to one other via an associated communication bus (not shown) and further that the hardware and/or software through which the respective structural components 705 through 725 perform the respective functionality associated therewith can overlap in part. For example, any software used to facilitate the functionality associated with the structural components 705 through 725 can be stored in the non-transitory memory associated with the memory configured to store information 715, such that the configured structural components 705 through 725 each perform the respective functionality associated therewith (i.e., in this case, software execution) based in part upon the operation of the software stored in the memory configured to store information 715. Likewise, hardware that is directly associated with one of the structural components 705 through 725 can be borrowed or used by other structural components 705 through 725 from time to time. For example, the at least one processor configured to process information 710 can format data into an appropriate format before being transmitted via the transceiver circuitry configured to transmit and/or receive information 705, such that the transceiver circuitry configured to transmit and/or receive information 705 performs the functionality associated therewith (i.e., in this case, transmission of data) based in part upon the operation of structural hardware associated with the at least one processor configured to process information 710.

Accordingly, those skilled in the art will appreciate that the various structural components 705 through 725 as shown in FIG. 7 are intended to invoke an aspect that is at least partially implemented with structural hardware, and are not intended to map to software-only implementations that are independent of hardware and/or non-structural (e.g., purely functional) interpretations. Furthermore, those skilled in the art will appreciate other interactions or cooperation between the structural components 705 through 725.

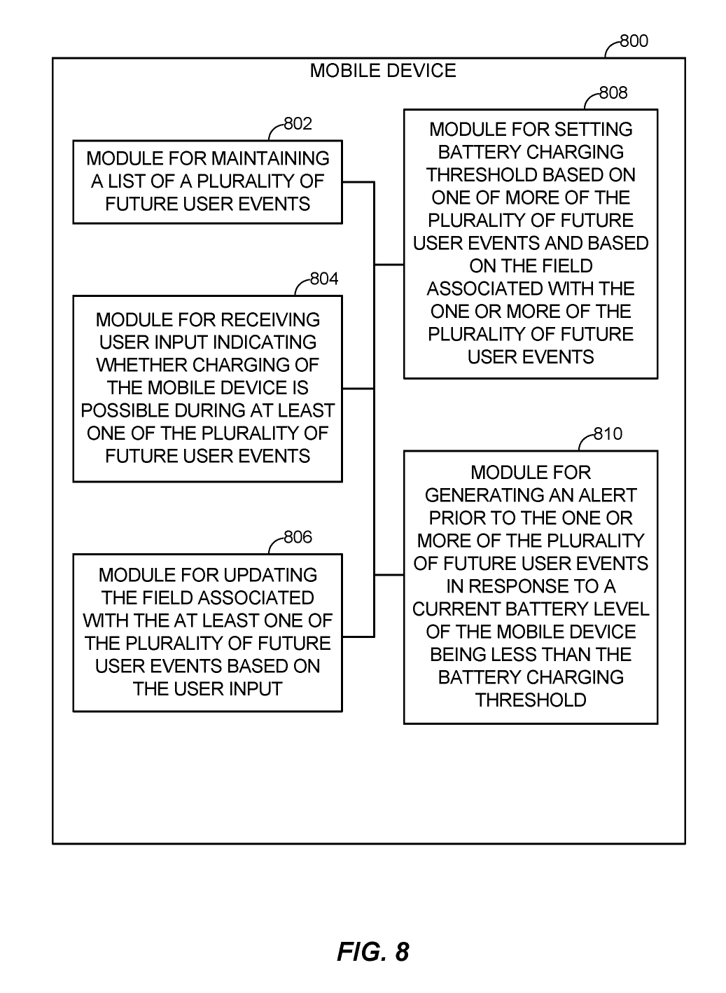

FIG. 8 is a simplified block diagram of several sample aspects of a mobile device 800 configured to support the dynamic setting of a battery charging threshold, according to various aspects. Mobile device 800 is one possible implementation of any of the mobile devices discussed above, and may be configured to perform one or more of the process blocks 102-110 of process 100 of FIG. 1 and/or one or more of the process blocks 402-412 of process 400 of FIG. 4. FIG. 8 illustrates mobile device 800 represented as a series of interrelated functional modules. A module 802 for maintaining a list of a plurality of future user events may correspond at least in some aspects to, for example, processor 608, memory 612, and/or I/O interface 614 of FIG. 6, as discussed herein. A module 804 for receiving user input indicating whether charging of the mobile device is possible during at least one of the plurality of future user events may correspond at least in some aspects to, for example, processor 608, memory 612, and/or I/O interface 614 of FIG. 6. A module 806 for updating the field associated with the at least one of the plurality of future user events based on the user input may correspond at least in some aspects to, for example, processor 608, memory 612, and/or I/O interface 614 of FIG. 6. A module 808 for setting the battery charging threshold based on one or more of the plurality of future user events and based on the field associated with the one or more of the plurality of future user events may correspond at least in some aspects to, for example, processor 608, memory 612, and/or I/O interface 614 of FIG. 6. A module 810 for generating an alert prior to the one or more of the plurality of future user events in response to a current battery level of the mobile device being less than the battery charging threshold may correspond at least in some aspects to, for example, processor 608, memory 612, I/O interface 614, and/or battery 616 of FIG. 6.

The functionality of the modules of FIG. 8 may be implemented in various ways consistent with the teachings herein. In some designs, the functionality of these modules may be implemented as one or more electrical components. In some designs, the functionality of these blocks may be implemented as a processing system including one or more processor components. In some designs, the functionality of these modules may be implemented using, for example, at least a portion of one or more integrated circuits (e.g., an ASIC). As discussed herein, an integrated circuit may include a processor, software, other related components, or some combination thereof. Thus, the functionality of different modules may be implemented, for example, as different subsets of an integrated circuit, as different subsets of a set of software modules, or a combination thereof. Also, it will be appreciated that a given subset (e.g., of an integrated circuit and/or of a set of software modules) may provide at least a portion of the functionality for more than one module.

In addition, the components and functions represented by FIG. 8, as well as other components and functions described herein, may be implemented using any suitable means. Such means also may be implemented, at least in part, using corresponding structure as taught herein. For example, the components described above in conjunction with the “module for” components of FIG. 8 also may correspond to similarly designated “means for” functionality. Thus, in some aspects one or more of such means may be implemented using one or more of processor components, integrated circuits, or other suitable structure as taught herein.

Those skilled in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those skilled in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted to depart from the scope of the various aspects and embodiments described herein.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The methods, sequences and/or algorithms described in connection with the aspects disclosed herein may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in an IoT device. In the alternative, the processor and the storage medium may reside as discrete components in a user terminal.

In one or more exemplary aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, DSL, or wireless technologies such as infrared, radio, and microwave, then the coaxial cable, fiber optic cable, twisted pair, DSL, or wireless technologies such as infrared, radio, and microwave are included in the definition of a medium. The term disk and disc, which may be used interchangeably herein, includes CD, laser disc, optical disc, DVD, floppy disk, and Blu-ray discs, which usually reproduce data magnetically and/or optically with lasers. Combinations of the above should also be included within the scope of computer-readable media.

While the foregoing disclosure shows illustrative aspects and embodiments, those skilled in the art will appreciate that various changes and modifications could be made herein without departing from the scope of the disclosure as defined by the appended claims. The functions, steps and/or actions of the method claims in accordance with the aspects and embodiments described herein need not be performed in any particular order. Furthermore, although elements may be described above or claimed in the singular, the plural is contemplated unless limitation to the singular is explicitly stated.

What is claimed is:

1. A method, comprising:
maintaining, at a mobile device, a list of a plurality of future user events, wherein the list includes a field associated with each of the plurality of future user events to indicate whether charging of the mobile device is possible during a respective future user event;
receiving, at the mobile device, user input in indicating whether charging of the mobile device is possible during at least one of the plurality of future user events;
updating the field associated with the at least one of the plurality of future user events to indicate whether charging of the mobile device is possible during the at least one of the plurality of future user events based on the user input;
setting a battery charging threshold of the mobile device based on one or more of the plurality of future user events and based on the field associated with the one or more of the plurality of future user events; and
generating an alert prior to the one or more of the plurality of future user events in response to a current battery level of the mobile device being less than the battery charging threshold.

2. The method of claim 1, wherein maintaining the list of the plurality of future user events comprises maintaining a calendar of the plurality of future user events, wherein each of the plurality of future user events is a calendar entry in the calendar.

3. The method of claim 2, wherein receiving the user input indicating whether charging of the mobile device is possible during the at least one of the plurality of future user events comprises generating a user interface corresponding to a calendar entry providing a user of the mobile device an option to classify the calendar entry as a future user event where charging of the mobile device is not possible.

4. The method of claim 1, wherein at least one future user event included in the list of the plurality of future events includes a start time, wherein setting the battery charging threshold further comprises:
determining whether a difference between the start time of the at least one future user event and a current time of the mobile device is less than a threshold;
in response to determining that the difference is less than the threshold, determining whether the field associated with the at least one future user event indicates that charging is possible during the at least one future user event;
setting the battery charging threshold to a first value in response to the field indicating that charging is possible during the at least one future user event; and
setting the battery charging threshold to a second value in response to the field indicating that charging is not possible during the at least one future user event, wherein the second value is greater than the first value.

5. The method of claim 4, further comprising:
maintaining a charging history associated with at least one past user event;
determining whether the at least one future user event matches the at least one past user event; and if so,
setting the battery charging threshold to the first value in response to the charging history associated with the at least one past user event indicating that charging is possible regardless of whether the field associated with the at least one future user event indicates that charging is not possible during the at least one future user event.

6. The method of claim 4, further comprising:
maintaining a charging history associated with at least one past user event;
determining whether the future user event matches the at least one past user event; and if so,
setting the battery charging threshold to the second value in response to the charging history associated with the at least one past user event indicating that charging is not possible regardless of whether the field associated with the at least one future user event indicates that charging is possible during the at least one future user event.

7. The method of claim 1, wherein setting the battery charging threshold further comprises:
determining an expected battery usage during the one or more of the plurality of future user events, wherein setting the battery charging threshold of the mobile device is based on one or more of the plurality of future user events, the field associated with the one or more of the plurality of future user events, and the expected battery usage during the one or more of the plurality of future user events.

8. The method of claim 7 wherein the list of the plurality of future user events includes a first field and a second field associated with each of the plurality of future user events, the first field indicating whether charging of the mobile device is possible during a respective future user event, and the second field indicating an activity type of the respective future user event, wherein determining the expected battery usage is based, in part, on the second field associated with the one or more of the plurality of future user events indicating the activity type.

9. The method of claim 8, further comprising:
determining whether the activity type is either one where charging of the mobile device is possible, or one where charging of the mobile device is not possible.

10. The method of claim 8, wherein the activity type is one of a plurality of activity types, the method further comprising:
associating at least some of the plurality of activity types with a higher expected battery usage than other activity types of the plurality of activity types.

11. The method of claim 7, wherein determining the expected battery usage during the one or more of the plurality of future user events is based on a prior history of battery usage by the mobile device during at least one past user event.

12. The method of claim 1, further comprising:
receiving from another device, an indication of a planned power outage at a location associated with the one or more of the plurality of future user events, wherein setting the battery charging threshold is further based on the indication of the planned power outage.

13. The method of claim 1, further comprising:
determining whether wireless charging is available for the mobile device; and
initiating wireless charging of the mobile device in response to the current battery level of the mobile device being less than the battery charging threshold.

14. A mobile device, comprising:
a battery;
memory adapted to store program code; and
a processor coupled to the memory to access and execute instructions included in the program code to direct the mobile device to:
maintain a list of a plurality of future user events, wherein the list includes a field associated with each of the plurality of future user events to indicate whether charging of the mobile device is possible during a respective future user event;
receive user input in indicating whether charging of the mobile device is possible during at least one of the plurality of future user events;
update the field associated with the at least one of the plurality of future user events to indicate whether charging of the mobile device is possible during the at least one of the plurality of future user events based on the user input;
set a battery charging threshold associated with the battery of the mobile device based on one or more of the plurality of future user events and based on the field associated with the one or more of the plurality of future user events; and
generate an alert prior to the one or more of the plurality of future user events in response to a current battery level of the battery being less than the battery charging threshold.

15. The mobile device of claim 14, wherein the instructions to maintain the list of the plurality of future user events comprises instructions to maintain a calendar of the plurality of future user events, wherein each of the plurality of future user events is a calendar entry in the calendar, and wherein the instructions to receive the user input indicating whether charging of the mobile device is possible during the at least one of the plurality of future user events comprises instructions to generate a user interface corresponding to a calendar entry providing a user of the mobile device an option to classify the calendar entry as a future user event where charging of the mobile device is not possible.

16. The mobile device of claim 14, wherein at least one future user event included in the list of the plurality of future user events includes a start time, wherein the instructions to set the battery charging threshold further comprises instructions to direct the mobile device to:
determine whether a difference between the start time of the at least one future user event and a current time of the mobile device is less than a threshold;
in response to determining that the difference is less than the threshold, determine whether the field associated with the at least one future user event indicates that charging is possible during the at least one future user event;
set the battery charging threshold to a first value in response to the field indicating that charging is possible during the at least one future user event; and
set the battery charging threshold to a second value in response to the field indicating that charging is not possible during the at least one future user event, wherein the second value is greater than the first value.

17. The mobile device of claim 16, wherein the program code further comprises instructions to direct the mobile device to:
maintain a charging history associated with at least one past user event;
determine whether the at least one future user event matches the at least one past user event; and if so,
set the battery charging threshold to the first value in response to the charging history associated with the at least one past user event indicating that charging is possible regardless of whether the field associated with the at least one future user event indicates that charging is not possible during the at least one future user event; and
set the battery charging threshold to the second value in response to the charging history associated with the at least one past user event indicating that charging is not possible regardless of whether the field associated with the at least one future user event indicates that charging is possible during the at least one future user event.

18. The mobile device of claim 14, wherein the instructions to set the battery charging threshold further comprises instructions to direct the mobile device to:
determine an expected battery usage during the one or more of the plurality of future user events, wherein setting the battery charging threshold of the mobile device is based on one or more of the plurality of future user events, the field associated with the one or more of the plurality of future user events, and the expected battery usage during the one or more of the plurality of future user events.

19. The mobile device of claim 18, wherein the list of the plurality of future user events a first field and a second field associated with each of the plurality of future user events, the first field indicating whether charging of the mobile device is possible during a respective future user event, and the second field indicating an activity type of the respective future user event, wherein determining the expected battery usage is based, in part, on the second field associated with the one or more of the plurality of future user events indicating the activity type.

20. The mobile device of claim 19, wherein the program code further comprises instructions to direct the mobile device to:
determine whether the activity type is either one where charging of the mobile device is possible, or one where charging of the mobile device is not possible.

21. The mobile device of claim 19, wherein the activity type is one of a plurality of activity types, the program code further comprising instructions to direct the mobile device to:
associate at least some of the plurality of activity types with a higher expected battery usage than other activity types of the plurality of activity types.

22. The mobile device of claim 18, wherein the instructions to determine the expected battery usage during the one or more of the plurality of future user events includes instructions to determine the expected battery usage based on a prior history of battery usage by the mobile device during at least one past user event.

23. The mobile device of claim 14, wherein the program code further comprises instructions to direct the mobile device to:
receive from another device, an indication of a planned power outage at a location associated with the one or more of the plurality of future user events, wherein the instructions to set the battery charging threshold includes instructions to set the battery charging threshold further based on the indication of the planned power outage.

24. The mobile device of claim 14, wherein the program code further comprises instruction to direct the mobile device to:
determine whether wireless charging is available for the mobile device; and
initiate wireless charging of the mobile device in response to the current battery level of the mobile device being less than the battery charging threshold.

25. A non-transitory computer-readable medium including program code stored thereon for use by a mobile device, the program code comprising instructions to direct the mobile device to:
maintain a list of a plurality of future user events, wherein the list includes a field associated with each of the plurality of future user events to indicate whether charging of the mobile device is possible during a respective future user event;
receive user input in indicating whether charging of the mobile device is possible during at least one of the plurality of future user events;
update the field associated with the at least one of the plurality of future user events to indicate whether charging of the mobile device is possible during the at least one of the plurality of future user events based on the user input;
set a battery charging threshold associated with the battery of the mobile device based on one or more of the plurality of future user events and based on the field associated with the one or more of the plurality of future user events; and
generate an alert prior to the one or more of the plurality of future user events in response to a current battery level of the battery being less than the battery charging threshold.

26. The non-transitory computer-readable medium of claim 25, wherein the instructions to maintain the list of the plurality of future user events comprises instructions to maintain a calendar of the plurality of future user events, wherein each of the plurality of future user events is a calendar entry in the calendar, and wherein the instructions to receive the user input indicating whether charging of the mobile device is possible during the at least one of the plurality of future user events comprises instructions to generate a user interface corresponding to a calendar entry providing a user of the mobile device an option to classify the calendar entry as a future user event where charging of the mobile device is not possible.

27. The non-transitory computer-readable medium of claim 25, wherein at least one future user event included in the list of the plurality of future events includes a start time, wherein the instructions to set the battery charging threshold further comprise instructions to direct the mobile device to:
determine whether a difference between the start time of the at least one future user event and a current time of the mobile device is less than a threshold;
in response to determining that the difference is less than the threshold, determine whether the field associated with the at least one future user event indicates that charging is possible during the at least one future user event;
set the battery charging threshold to a first value in response to the field indicating that charging is possible during the at least one future user event; and
set the battery charging threshold to a second value in response to the field indicating that charging is not possible during the at least one future user event, wherein the second value is greater than the first value.

28. A mobile device, comprising:
a battery;
means for maintaining, at the mobile device, a list of a plurality of future user events, wherein the list includes a field associated with each of the plurality of future user events to indicate whether charging of the mobile device is possible during a respective future user event;
means for receiving, at the mobile device, user input in indicating whether charging of the mobile device is possible during at least one of the plurality of future user events;
means for updating the field associated with the at least one of the plurality of future user events to indicate whether charging of the mobile device is possible during the at least one of the plurality of future user events based on the user input;
means for setting a battery charging threshold associated with the battery of the mobile device based on one or more of the plurality of future user events and based on the field associated with the one or more of the plurality of future user events; and
means for generating an alert prior to the one or more of the plurality of future user events in response to a current battery level of the battery being less than the battery charging threshold.

29. The mobile device of claim 28, wherein the means for maintaining the list of the plurality of future user events comprises means for maintaining a calendar of the plurality of future user events, wherein each of the plurality of future user events is a calendar entry in the calendar, and wherein the means for receiving the user input indicating whether charging of the mobile device is possible during the at least one of the plurality of future user events comprises means for generating a user interface corresponding to a calendar entry providing a user of the mobile device an option to classify the calendar entry as a future user event where charging of the mobile device is not possible.

30. The mobile device of claim 28, wherein at least one future user event included in the list of the plurality of future events includes a start time, wherein the means for setting the battery charging threshold further comprises:
means for determining whether a difference between the start time of the at least one future user event and a current time of the mobile device is less than a threshold;
means for determining whether the field associated with the at least one future user event indicates that charging is possible during the at least one future user event;
means for setting the battery charging threshold to a first value in response to the field indicating that charging is possible during the at least one future user event; and
means for setting the battery charging threshold to a second value in response to the field indicating that charging is not possible during the at least one future user event, wherein the second value is greater than the first value.
